(19) United States
(12) Patent Application Publication
(10) Pub. No.: US 2001/0040562 A1
(43) Pub. Date: Nov. 15, 2001

(54) Input device having plurality of function switches

(75) Inventor: Hideki Masudaya, Miyagi-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 09/837,988

(22) Filed: Apr. 19, 2001

(30) Foreign Application Priority Data
Apr. 28, 2000 (JP) 2000-134284

(51) Int. Cl. G09G 5/00

(52) U.S. Cl. 345/173

(57) ABSTRACT

The present invention provides an input device allowing automatic customization of selection of function switches and functions assigned to the operating direction of a manual operating pad in a manner most suitable to the habit and subjective bias of operators to prevent any mistakes. The input device includes a mistake counter means, which increments the counted number of mistakes by determining, when any part of an input unit is operated within a predetermined period of time after another part of the input unit has been operated, that the preceding operation is a mistake; and a controller unit will replace the function assigned to the preceding operating action with another function in a function table, when the counted number of times of mistakes reaches a predetermined number.

### BACKGROUND OF THE INVENTION

1. Field of the Invention

The present invention relates to an input device having a plurality of function switches, and more particularly to an input device for used in a vehicle to operate electronic devices on board by only one input device to reduce operation errors by overriding functions assigned to switches.

2. Description of the Prior Art

Recently, automobiles have a number of electronic devices equipped, including CD player, MD player, radio, air conditioner, TV receiver, and telephone. These devices are each mounted at a different place, and when a driver wants to control one of these devices the driver's attention ahead will be distracted to reduce safety for driving. An input device or control center mounted on the instrument panel to control the on-board devices therefrom has been devised as a solution.

An exemplary control center will be described by referring to FIG. 10 to FIG. 16. FIG. 10 is an overview of an control center. As shown in FIG. 10, a control center 100 includes six function switches 101a, 101b, 101c, 101d, 101e, and 101f, and a multiple directive input device 103 having a manual operating pad 102 having four-way operation in the forward, backward, right and left directions. When selecting one of function switches 101a, 101b, 10c, 101d, 101e, and 101f, one of devices among for example the CD (or MD), radio, air conditioner 1, air conditioner 2, TV and telephone will be controlled, in correspondence with the key pressed.

FIG. 11 to FIG. 16 show functions which correspond to the operating direction of the manual operating pad 102 and each of which are selected by the function switches 101a to 101f. For example, as shown in FIG. 11, when pressing the function switch 101c to select the air conditioner 1, the operation of the manual operating pad 102 in either the forward (upward), backward (downward) left, and right direction will correspondingly control the air conditioner 1 to scroll up the blower outlet, to scroll down the blower outlet, to increase the blower power, or to decrease the blower power, respectively. In addition, as shown in FIG. 12 to FIG. 16, when another device is selected, the operating direction of the manual operating pad 102 will control a preset function of the selected device. As can be seen, the control center 100 may control some functions of a plurality of electronic devices by combination of the selection of function switches 101a to 101f with the operating direction of the manual operating pad 102.

When the operator is the driver, for example while driving a car, the operator-driver needs to watch out for walkers and other vehicles ahead to keep safe driving. This implies that the operator-driver must operate the control center 100 by blind touch, i.e., without looking at it, and that this requires the operator-driver to well understand the function of each of keys 101a to 101f and manual operating pad 102, what will be happen in operating the manual operating pad 102 in which direction, or which of switches 101a to 101f will bring on to the control. However it will be difficult to force every driver to memorize all of functionalities correctly and personal habits or bias may cause a misunderstanding or misapprehension.

For instance, as shown in FIG. 11, the direction-distance from the driver is used as the reference for controlling the blower power of the air conditioner, in correspondence with the power of the blower, such that for example the blower will be powered up when operating the manual operating pad 102 in leftward (in the direction going apart from the driver-operator in a right hand drive), and the blower will be powered down when the manual operating pad 102 is manipulated in rightward (in the direction coming closer to the driver-operator in a right hand drive). For example, as is often the case with someone who uses drawing X-Y coordinate system in the work, rightward move may mean an increase whereas leftward move may mean a decrease. When this person operates the control center in the wrong way and realizes the mistake, the person will attempt to readjust in a hurry, causing the danger of an accident.

Although a customizable control center that allows the correspondence between the operating direction of the manual operating pad 102 and one of the functions in the function switches 101a to 101f to be manually customized has been devised and proposed, customizing of the control center for all electronic devices on board or in every operating directions will be cumbersome and may be time-consuming work.

### SUMMARY OF THE INVENTION

The present invention has been made in view of the above circumstances and has an object to overcome the above problems and to provide an input device that allows the correspondence between the operating direction of the manual operating pad and the functionality or the correspondence between the function switches and the controlled devices to be customized in accordance with the habit or bias to reduce operation errors.

To achieve the object and in accordance with the purpose of the invention, as embodied and broadly described herein, the present invention comprises: a plurality of function switches each provided corresponding to a plurality of electronic devices for selecting one of these devices; a controller unit for controlling the electronic devices; a warning unit for generating warning signals for informing an operator of a mistaken action; and a mistake counter means for monitoring the operation to count and store the number of mistakes on each of the function switches, wherein the mistake counter means increments the counted number of mistakes by determining, when one of the function switches is operated within a predetermined period of time after another function switch has been operated, that the preceding switch operation is a mistake; and the controller unit instructs the warning unit to generate the warning signals when the counted number of mistakes reaches a predetermined threshold number. The operator may recognize which function switch is most prone to make a mistake, and will take care of operation much carefully when acting on the erroneous operation, resulting in a gradually decrease of erroneous operation on the function switches.

In addition, in accordance with the present invention, the controller unit allows the electronic device selected by a function switch operated in the first action to be replaced with another device assigned to another function switch after generating the warning signals. The operator is allowed thereby to decide whether to perform the reassignment of a device assigned to the most erroneously operating function switch with another device assigned to another function switch. When performing the reassignment and after some iteration of the reassignment, the device assignment on the function switches 21a to 21f will be modified to be most suitably conformed to the habit and subjective prejudice of the operator, ultimately resulting in a significant decrease of mistaken actions on the function switches, without a complex procedure of customization.

Also, the present invention comprises: a plurality of function switches each provided corresponding to a plurality of electronic devices for selecting one of the devices; a controller unit for controlling the electronic devices; and a mistake counter means for monitoring the operation to count and store the number of mistakes for each of the function switches, wherein the mistake counter means increments the counted number of mistakes by determining, when one of the function switches is operated within a predetermined period of time after another function switch has been operated, that the preceding switch operation is a mistake; and the controller unit replaces the assigned electronic device selected by the function switch operated in the preceding action with another electronic device selected by another function switch, when the counted number of mistakes reaches a predetermined threshold number. The component that is assigned to a function switch most prone to make a mistake will be automatically swapped with another component assigned to another function switch. After some iteration of this reassignment, the device assignment on the function switches 21a to 21f will be modified to be most suitably conformed to the habit and subjective bias of the operator, ultimately resulting in a significant decrease of mistaken actions on the function switches, without responding to warning signals from the warning unit each time.

In addition, the present invention further comprises a warning unit for generating notification signals for informing an operator of the automatic reassignment of the electronic device, wherein the controller unit instructs the warning unit to generate the notification signals when the device reassignment has been performed. The operator may confirm the reassignment to be assured.

In accordance with the present invention, the function switches are provided in a console box and the electronic devices selected by the function switches are electric components equipped in an automobile. Since while driving a vehicle such operations have to be done in blind touch, driving will be much safer while operating these function switches.

Also, the present invention comprises: a plurality of function switches each provided corresponding to a plurality of electronic devices for selecting one of these devices; a manual operating pad manipulatable in two or more directions for selecting a functionality of the electronic device by the operating direction; a controller unit for instructing the electronic devices to execute the functions; a warning unit for generating warning signals for informing an operator of a mistaken action; and a mistake counter means for monitoring the operation to count and store the number of mistakes in each operating direction of the manual operating pad, wherein the mistake counter means increments the counted number of mistakes in an operating direction by determining, when the manual operating pad is operated in a direction within a predetermined period of time after the pad has been operated in another direction, that the preceding switch operation is a mistake; and the controller unit instructs the warning unit to generate warning signals when the counted number of mistakes reaches a predetermined threshold number. The operator may recognize the operating direction of the manual operating pad the most prone to make a mistake, and will take care of the action thereafter when operating the most erroneous function, resulting in a gradual decrease of actions on the manual operating pad.

In addition, in accordance with the present invention, the assignment of the electronic device selected by the preceding action to an operating direction can be swapped with another assignment of another device selected in another direction by means of the controller unit after generating the warning signals. The operator may have option to perform or not a reassignment of the operating direction with another function assigned to another direction. When instructing to do and after some iteration of the reassignment, the device assignment on the operating directions of the manual operating pad will be modified to be most suitably conformed to the habit and subjective prejudice of the operator, ultimately resulting in a significant decrease of mistakes on the pad operation, without a complex procedure of customization.

Also the present invention comprises: a plurality of function switches each provided corresponding to a plurality of electronic devices for selecting one of the devices; a manual operating pad manipulatable in two or more directions for selecting a functionality of the electronic device by the operating direction; a controller unit for instructing the electronic devices to execute the functions; and a mistake counter means for monitoring the operation to count and store the number of mistakes in each operating direction of the manual operating pad, wherein the mistake counter means increments the counted number of mistakes in an operating direction by determining, when the manual operating pad is operated in a direction within a predetermined period of time after the manual operating pad has been operated in another direction, that the preceding switch operation is a mistake; and the controller unit replaces the function selected by the operating direction in a preceding action with another function selected in a succeeding action when the counted number of mistakes reaches a predetermined threshold number. The function assigned to an operating direction most prone to make a mistake by the operator will be automatically swapped with another function assigned to another direction, and some iteration of the reassignment, the function assignment on the operating directions will be modified to be most suitably conformed to the habit and subjective bias of the operator, ultimately resulting in a significant decrease of mistaken actions on the manual operating pad, without responding to warning signals from the warning unit each time.

In addition, the present invention further comprises a warning unit for generating notification signals for informing the operator of the reassignment done, wherein the controller unit instructs the warning unit to generate the notification signals when the device reassignment has been performed. The operator may recognize the reassignment and will be assured to operate on the manual operating pad.

Also, in accordance with the present invention, the function switches and the manual operating pad are mounted in a console box of an automobile and the electronic devices are the electric components equipped on board selected by the function switches, as well as the functions are individual functions of each of the electronic components in an automobile. Since while driving a vehicle such operations have to be done in blind touch, driving will become much safer while operating these function switches and manual operating pad.

The above and further objects and novel features of the present invention will more fully appear from following detailed description when the same is read in connection with the accompanying drawings. It is to be expressly understood, however, that the accompanying drawings are for the purpose of illustration only and not intended as a definition of the limits of the present invention.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention. In the drawings,

FIG. 1 is a schematic block diagram of an input device in accordance with the present invention;

FIG. 2 is a schematic diagram of an input device in accordance with the present invention;

FIG. 3 is an exemplary function table illustrating the combination of the assignments of function switches and the operating directions of the manual operating pad with individual functions in an input device in accordance with the present invention;

FIG. 4 is an example of the count of mistakes stored in a mistake counter means of first and second embodiments in accordance with the present invention;

FIG. 5 is a flowchart illustrating the control flow in first preferred embodiment of the present invention;

FIG. 6 is a flowchart illustrating the control flow in second preferred embodiment of the present invention;

FIG. 7 is an example of the count of mistakes stored in a mistake counter means of third and fourth embodiments in accordance with the present invention;

FIG. 8 is a flowchart illustrating the control flow in third preferred embodiment of the present invention;

FIG. 9 is a flowchart illustrating the control flow in fourth preferred embodiment of the present invention;

FIG. 10 is a schematic diagram of the input device in accordance with the Prior Art;

FIG. 11 is a schematic diagram illustrating the correspondence of the operating direction of the manual operating pad to the assigned function of the air conditioner 1 in the input device of the Prior Art;

FIG. 12 is a schematic diagram illustrating the correspondence of the operating direction of the manual operating pad to the assigned function of the air conditioner 2 in the input device of the Prior Art;

FIG. 13 is a schematic diagram illustrating the correspondence of the operating direction of the manual operating pad to the assigned function of the CD (MD) player in the input device of the Prior Art;

FIG. 14 is a schematic diagram illustrating the correspondence of the operating direction of the manual operating pad to the assigned function of the radio in the input device of the Prior Art;

FIG. 15 is a schematic diagram illustrating the correspondence of the operating direction of the manual operating pad to the assigned function of the TV in the input device of the Prior Art; and

FIG. 16 is a schematic diagram illustrating the correspondence of the operating direction of the manual operating pad to the assigned function of the telephone in the input device of the Prior Art.

### DETAILED DESCRIPTION OF THE PREFERRED EMBODIMENTS

[First Embodiment]

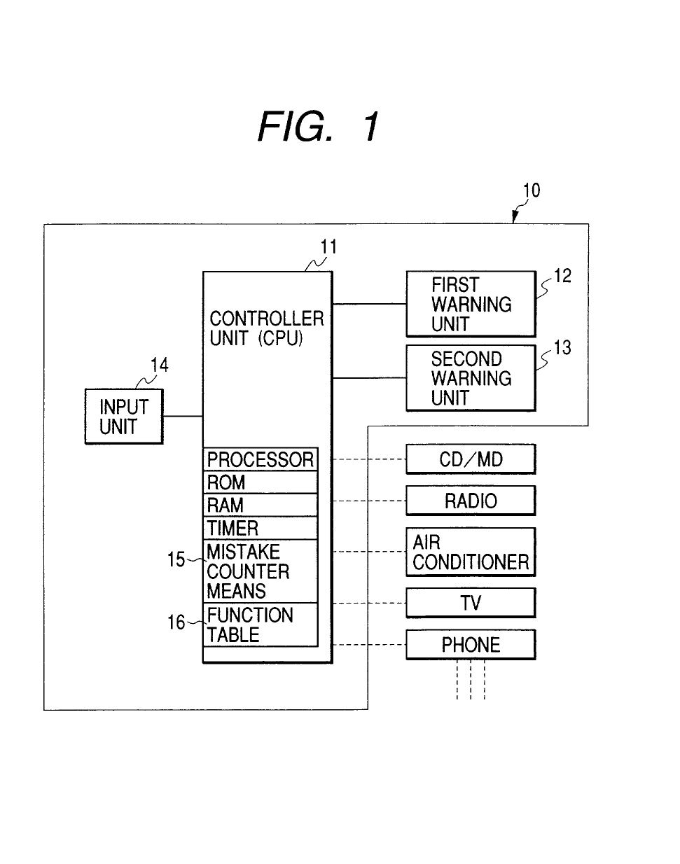

A detailed description of a first preferred embodiment embodying the present invention will now be given referring to the accompanying drawings, in particular to FIG. 1 to FIG. 5.

FIG. 1 shows a schematic block diagram of an input device embodiment in accordance with the present invention. As shown in the figure, the input device 10 includes a controller unit (CPU) 11, a first warning unit 12, a second warning unit 13, and an input unit 14.

The controller unit 11 includes a processor, a RAM, a ROM, a timer, a mistake counter means 15, and a function table 16. The controller unit 11 may have functionalities of receiving the input from the input unit 14, controlling the first and second warning units 12 and 13, and outputting control signals to those electronic devices such as a CD player, an MD player, a radio, an air conditioner, a TV, a telephone, and the like.

The first and second warning unit 12 and 13 may be, for example, LCDs, buzzers, LEDs or vibrators incorporated in the manual operating pad, which may be served for giving warning signs or for notifying the operator-driver of the command result of a component, by the command signals supplied from the controller unit 11.

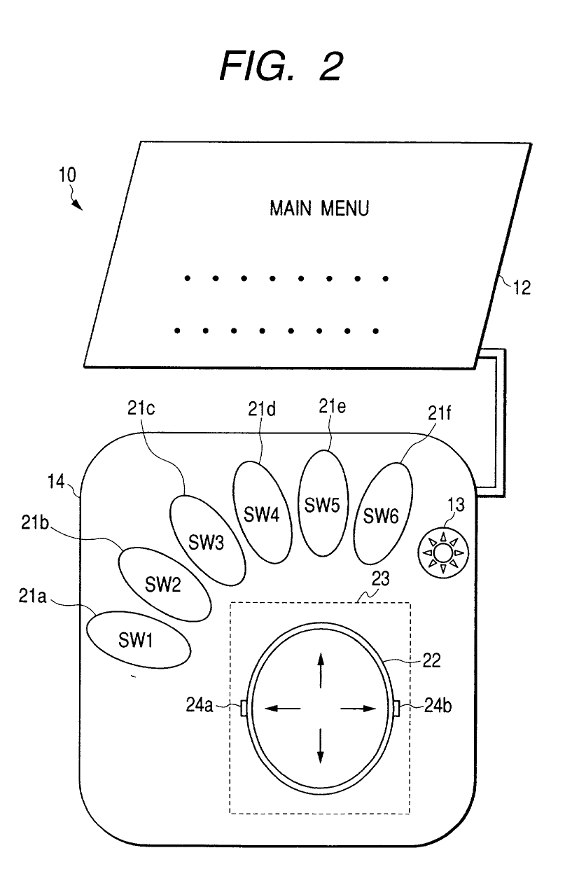

The input unit 14 as shown by the overview in FIG. 2, includes six function switches 21a, 21b, 21c, 21d, 21e, and 21f, and a multi-directional input device 23 having a manual operating pad 22 for manually operating in four directions of forward, backward, leftward, and rightward. Also, the manual operating pad 22 has two input switches 24a and 24b at both lateral sides.

The mistake counter means 15 may be invoked when the function switches 21a to 21f or the manual operating pad 22 are manipulated to monitor the actions so as to determine whether the action taken at that time is a mistakenly performed error or not to count and store the number of mistakes with respect to the selection of function switches 21a to 21f and the operating direction of the manual operating pad 22.

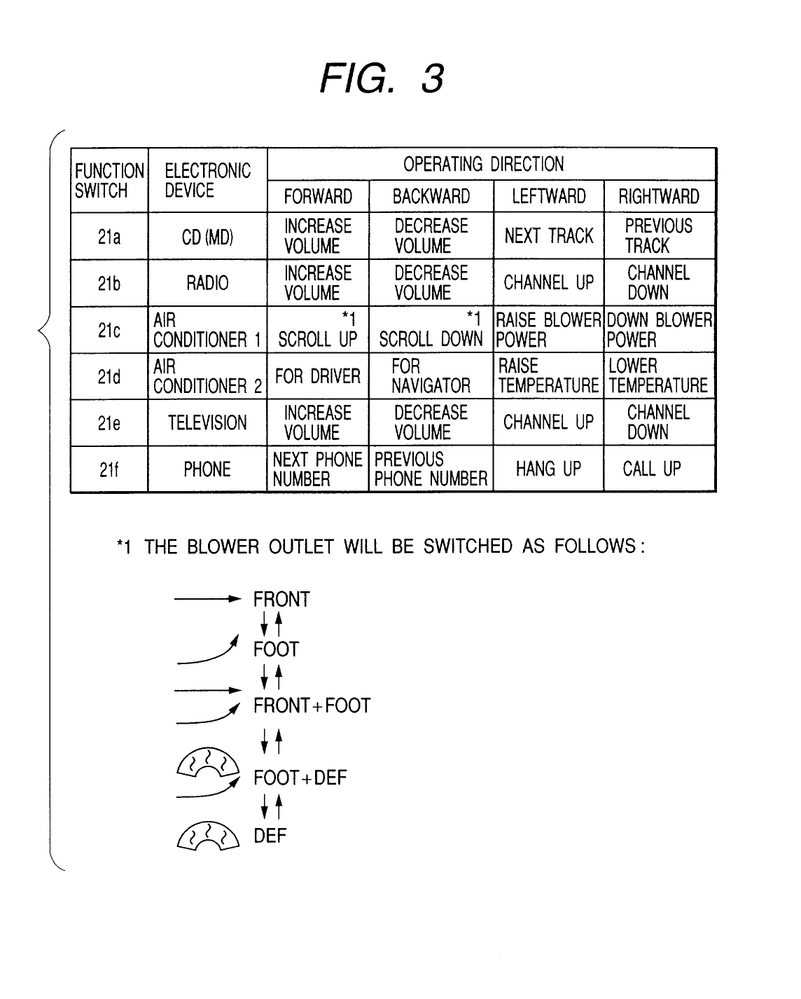

The function table 16 as shown in FIG. 3 is a reference table of the correspondence between the combination of the selection of function switches 21a to 21f with the operating direction of the manual operating pad 22 and individual function of the components connected. As shown in the figure, the function switches 21a to 21f are preset assigned to electronic devices and functions corresponding thereto are preset assigned to each of operating directions of the manual operating pad 22. The function table 16 may be held in the internal memory of the controller unit 11 in a manner rewritable by the controller unit 11 and non-volatile with the uninterrupted power supplied from the battery.

In this manner, when either of function switches 21a to 21f in the input unit 14 is selected and the manual operating pad 22 is commanded in either of directions, the controller unit 11 will refer to the function table 16 to execute a function assigned to the combination of operations of the selected one of function switches 21a to 21f with the direction of the manual operating pad 22. For example, when a function switch 21a is selected and the manual operating pad 22 is commanded in the forward direction, the controller unit 11 will execute a function so as to give louder sound of CD.

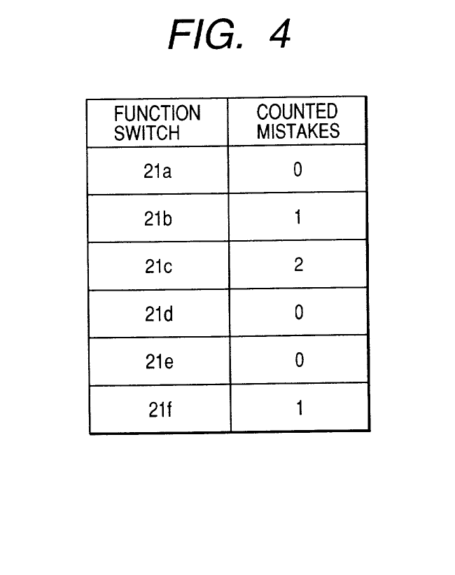

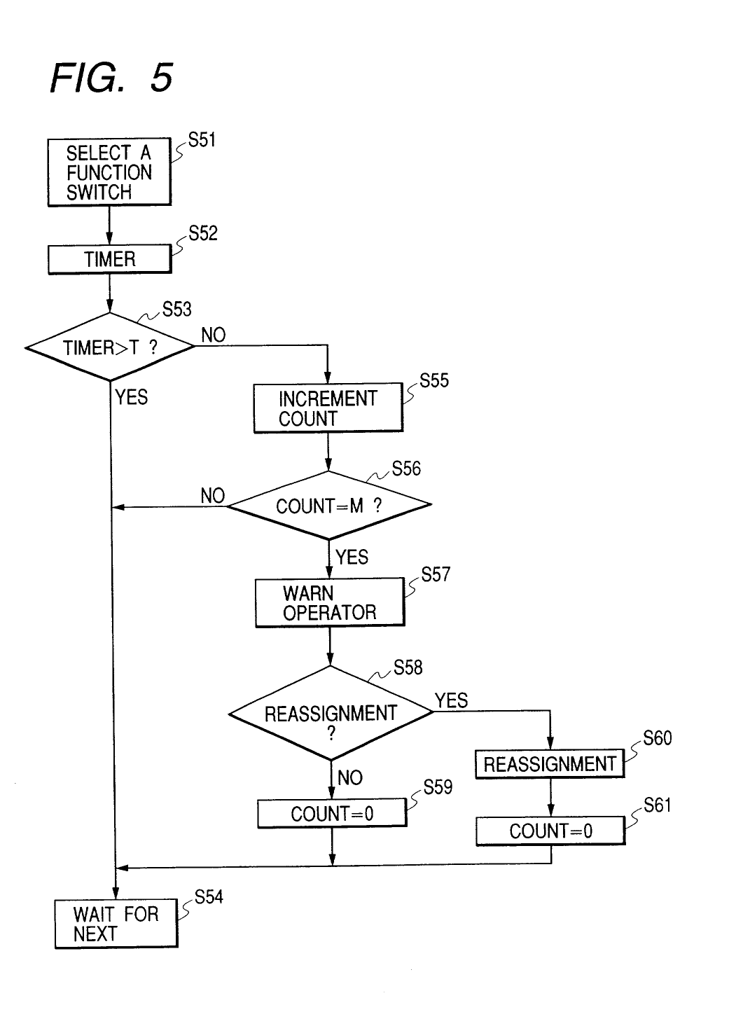

The operating procedure in the first preferred embodiment of the present invention will be described with reference to FIG. 5. When the operator selects one of the function switches 21a to 21f (step S51), the mistake counter means 15 will retrieve, from the internal timer circuit of the controller unit 11, the elapsed time since the last selection of function switches 21a to 21f to the present time (step S52). Then the mistake counter means 15 will compare the elapsed time with a predetermined (T sec.) period of time (step S53). If the elapsed time is longer than T, then the last operation of function switches 21a to 21f is determined not to be an error and the circuit waits for a next action on the function switches 21a to 21f (step S54). If the elapsed time is shorter than T, then the circuit will determine that the last action on the function switches 21a to 21f was a mistake, and increment the number of mistakes of the selected one of function switches 21a to 21f, which count is stored in the controller unit 11 as shown by an example in FIG. 4 (step S55). Then the circuit will compare thus incremented number of mistakes counted with a predetermined (M) number (step S56). If the counted number of mistakes is less than M, then the circuit will wait for the next action on the function switches 21a to 21f (step S54). If the counted number of mistakes is equal to M, then the controller unit 11 will output warning signals to the first warning unit 12 to warn the operator-driver. The first warning unit 12 is served for warning the operator to indicate that the counted mistakes of the previously selected one of the function switches 21a to 21f reaches a predetermined number and ask if the operator wishes to replace the component assigned to the last selected one of the function switches 21a to 21f with another component assigned to another one of the function switches 21a to 21f (step S57). Then the circuit will wait for the reply (input) from the operator (step S58). If there is no response after a predetermined period of time, then the counted mistakes of the last selected one of the function switches 21a to 21f will be initialized to zero (step S59) to wait for the next action on the function switches 21a to 21f (step S54) If the operator acts as the response, the circuit will replace the component assigned to the last selected one of the function switches 21a to 21f in the function table 16 with another swappable component assigned to another one of the function switches 21a to 21f (step S60) and will clear the counted mistakes of the last selected one of the function switches 21a to 21f (step S61) to wait for the next action on the function switches 21a to 21f (step S54).

If the first warning unit 12 is a display device such as an LCD, for example, the warning signals supplied will be the indication signals to be displayed on the LCD panel, which will provide thereby a warning display on the LCD for the operator (step S57). Then the LCD will display a message to the operator, while the operator in turn will follow the message to act in sequence accordingly to perform the replacement of assigned devices to the function switches 21a to 21f.

If the first warning unit 12 is an audio output device such as a loudspeaker, the warning signals will be indication for supplying voice instruction through the loudspeaker, for giving the operator a notification (step S57). Then the operator will understand by the voice instruction output from the loudspeaker that he or she has made a mistake in the touch operation on it as well as he or she will follow the instruction given by the audible guidance to act accordingly to replace the components assigned to the function switches 21a to 21f.

If the first warning unit 12 is a ringing device including a buzzer, a chime, or a bell, then the warning signals will be the indication for outputting sounds from the buzzer, which will give the operator through the buzzer a notification (step S57). Then the operator will understand that he or she has made an error by the sound output from the buzzer, and may be provided an option for example that the replacement will not be done when selecting a function switch 21b, whereas the replacement of the components assigned to the function switches 21a to 21f will be done by selecting another function switch 21a.

If the first warning unit 12 is a light emitting device including LEDs or a lamp, then the warning signs will be the indication for the LED to emit light, thereby the operator will be warned through the LEDs (step S57) Then the operator will understand by the light emitted from the LEDs that he or she has made an error and may be provided an option for example that the replacement will not be done when selecting a function switch 21b, whereas the replacement of the components assigned to the function switches 21a to 21f will be done by selecting another function switch 21a.

If the first warning unit 12 is a vibrator device incorporated in the manual operating pad 22, the warning signals may be the indication for the vibrator to vibrate, thereby the operator will be warned through the vibrator (step S57). Then the operator will understand by the vibration provided by the vibrator that he or she has made an error and may be provided an option for example that the replacement will not be done when selecting a function switch 21b, whereas the replacement of the components assigned to the function switches 21a to 21f will be done by selecting another function switch 21a.

It should be noted here that the present invention makes use of the nature that a human operator will attempt in a hurry to correct an error committed. It may be preferable, therefore, that the predetermined period of time T is in the range of one to three seconds, and that the predetermined counted number M is in the range of two to five.

Which one component assigned to the function switches 21a to 21f is the best candidate may be determined, desirably either at random or by the operator's choice of one of devices of the function switches 21a to 21f after the notification indication.

As can be appreciated from the foregoing description, a notification will be given when the total count of mistakes reaches a given threshold number. The operator may recognize which key is the most mistaken one among the function switches 21a to 21f, and will take care of actions on the most erroneous one of function switches 21a to 21f so that ultimately the erroneous operation on the function switches 21a to 21f will be decreased. Furthermore, when a device assigned to a key is swapped with another one, then the most erroneously operated device that has been assigned to one of the function switches 21a to 21f will be replaced with another device assigned to another one of the function switches 21a to 21f, and so on such that the assignment of devices to the function switches 21a to 21f will gradually fit to the habit or custom of the operator, resulting in a decrease of erroneous operation on the function switches 21a to 21f.

[Second Embodiment]

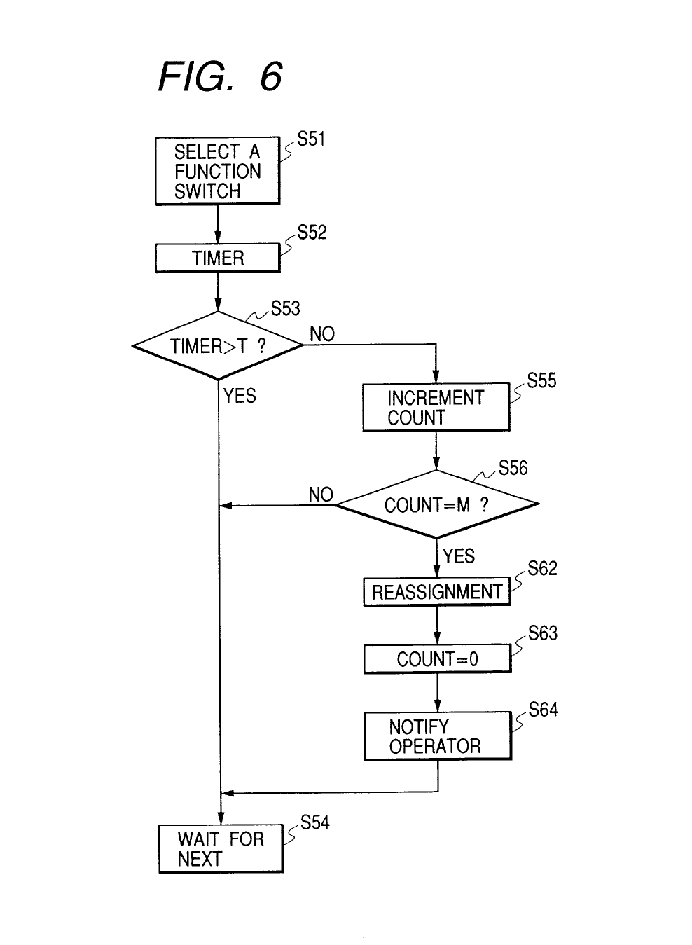

A second preferred embodiment of the present invention will be described in greater details by referring to FIG. 6. The input device in accordance with the second preferred embodiment has a similar configuration to the input device of the preceding first preferred embodiment as have been described herein above, and the steps S51 to S56 in the operating procedure in FIG. 6 are identical to the corresponding steps in FIG. 5 of S51 to S56, so that the detailed description of the parts already described in the preceding embodiment will be omitted.

The control flow in the second preferred embodiment may be such that the counted number of mistakes is compared with a predetermined number M (step S56), if the counted number is equal to M then the last selected device assigned to one of function switches 21a to 21f will be automatically replaced with another device assigned to another one of function switches 21a to 21f (step S62) thereafter the controller unit 11 will clear the count of mistakes on the last selected one of function switches 21a to 21f (step S63) and will instruct the second warning unit 13 to notify the operator of the device reassignment (step S64). And then the control will wait for the next action on the function switches 21a to 21f (step S54).

As can be appreciated from the foregoing description, a device assigned to one of the function switches 21a to 21f that is often erroneously operated may be automatically replaced with another device assigned to another one of the function switches 21a to 21f, allowing the operator not to do anything, and after some iteration of this flow the device assignment on the function switches 21a to 21f will be modified to be most suitably conformed to the habit and subjective prejudice of the operator, ultimately resulting in a significant decrease of mistaken actions on the function switches 21a to 21f. Since the controller unit notifies of the reassignment, the operator may confirm the automatic reassignment and will be assured.

[Third Embodiment]

Next, a third preferred embodiment of the present invention will be described in greater details with reference to FIG. 5. The present embodiment has the identical configuration as the preceding first embodiment, the similar members are designated to the identical reference numbers and the detailed description of the parts already described in the preceding embodiment will be omitted.

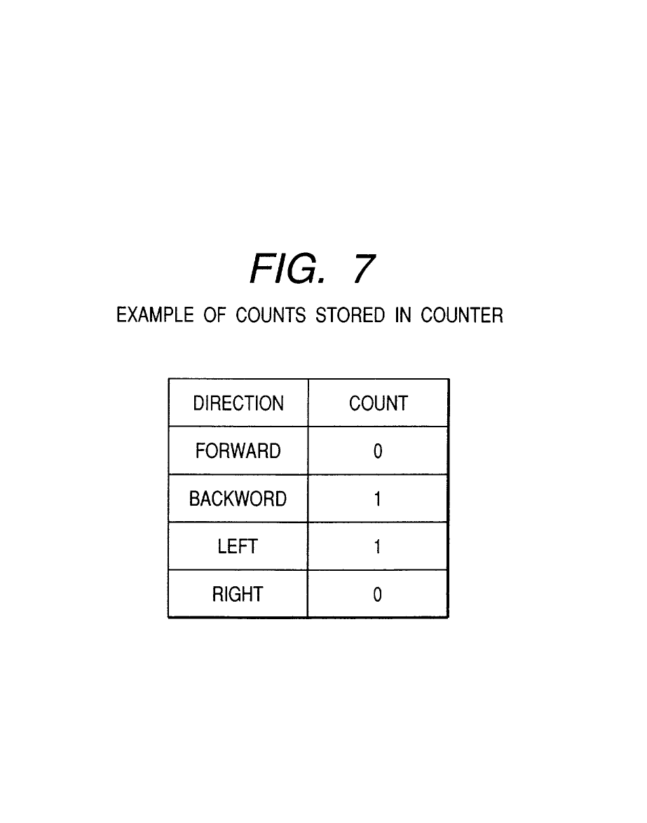

In the operation flow in accordance with the third preferred embodiment of the present invention, when the operator moves the manual operating pad 22 in either direction (step S81), the controller unit 11 will perform a function allocated to the combination of a device selected at that moment with the direction of operation of the manual operating pad 22 (step S82). Then the mistake counter means 15 will retrieve from the internal timer incorporated in the controller unit 11 the elapsed time since the last action on the manual operating pad 22 (step S83). Then the mistake counter means 15 will compare the retrieved elapsed time with a predetermined (T sec.) period of time (step S84). If in the comparison the elapsed time is longer than T, then the last action done on the manual operating pad 22 will be determined not to be a mistake, and the controller unit 11 will wait for the next action (step S85). If otherwise the elapsed time is shorter than T then the last action on the manual operating pad 22 will be determined to be an error, and then the count of mistakes stored in the controller unit 11 conforming to the last selected operating direction of the manual operating pad 22 will be incremented, as shown in FIG. 7 (step S86). Thereafter the count of mistakes will be compared with a predetermined (M) number (step S87). If the counted mistakes is less than M, then the control will wait for the next action on the manual operating pad 22 (step S85) If the counted mistakes is equal to M then the controller unit 11 will output warning signals to the first warning unit 12 for warning the operator, and the first warning unit 12 will notify the operator that the number of times of mistakes by the operator reached to a predetermined number of times since the last action on the manual operating pad 22, will ask the operator whether to perform the reassignment of device function assigned to the last selected direction of the manual operating pad 22 to another device function assigned to another direction of the manual operating pad 22 (step S88), and will wait for the response from the operator (step S89). If there is no action taken by the operator after a predetermined period of time, the count of mistakes in the last designated direction of the manual operating pad 22 will be nullified (step S90) and the flow will wait for the next action on the manual operating pad 22 (step S85). If the operator responds, then the function stored in the function table 16 and assigned to the last selected direction of the operation of the manual operating pad 22 will be replaced with another operating function assigned to another direction of the operation of the manual operating pad 22 (step S91), the count of mistakes of that last selected operating direction of the manual operating pad 22 will be nullified (step S92) to wait for the next action on the manual operating pad 22 (step S85).

If the first warning unit 12 is a display device such as an LCD panel, then the warning signals may be the indication to be displayed on the LCD, which will provide a notification to the operator on the LCD panel screen (step S88). A message to the operator will be displayed on the LCD screen, and the operator in turn will follow the instruction given by the message to act accordingly to swap the functions to be assigned to the operating directions of the manual operating pad 22.

If the first warning unit 12 is an audio output device such as a loudspeaker, the warning signals will be indication for supplying voice instruction through the loudspeaker, for giving the operator a notification (step S88). Then the operator will understand by the voice instruction output from the loudspeaker that he or she has made a mistake in the touch operation on it as well as he or she will follow the instruction given by the audible guidance to act accordingly to replace the functions assigned of operating directions to the manual operating pad 22.

If the first warning unit 12 is a ringing device including a buzzer, a chime, or a bell, then the warning signals will be the indication for outputting sounds from the buzzer, which will give the operator through the buzzer a notification (step S88). Then the operator will understand that he or she has made an error by the sound output from the buzzer, and may be provided an option for example that the replacement will not be done when operating the manual operating pad 22 backward whereas the replacement of the functions assigned to the manual operating pad 22 will be done by operating the manual operating pad 22 forwardly.

If the first warning unit 12 is a light emitting device including LEDs or a lamp, then the warning signs will be the indication for the LED to emit light, thereby the operator will be warned through the LEDs (step S88). Then the operator will understand by the light emitted from the LEDs that he or she has made an error and may be provided an option for example that the replacement will not be done when operating the manual operating pad 22 backward whereas the replacement of the functions assigned to the manual operating pad 22 will be done by operating the manual operating pad 22 forwardly.

If the first warning unit 12 is a vibrator device incorporated in the manual operating pad 22, the warning signals may be the indication for the vibrator to vibrate, thereby the operator will be warned through the vibrator (step S88). Then the operator will understand by the vibration provided by the vibrator that he or she has made an error and may be provided an option for example that the replacement will not be done when operating the manual operating pad 22 backward whereas the replacement of the functions assigned to the manual operating pad 22 will be done by operating the manual operating pad 22 forwardly.

As can be appreciated from the foregoing description, since the operator will be warned once the counted mistakes reach to a predetermined threshold number, the operator will act more carefully when operating instructions prone to make a mistake, so that ultimately the mistake in operating the manual operating pad 22 will be gradually reduced. When replacing functions, the function assigned to a direction of manual operating pad 22 prone to make a mistake will be reassigned by another function, and after some iteration of the reassignment the operating directions of the manual operating pad 22 will be most suitably conformed to the habit and subjective prejudice of the operator, ultimately resulting in a significant decrease of mistaken actions on the manual operating pad 22.

It can be appreciated by those skilled in the art that in the reassignment, which function is the best candidate to replace one prone to make a mistake may be the one that has been assigned to the opposite direction to the direction that the operator make a predetermined number of times of mistakes, however, the candidate may be chosen at random. Alternatively the desirable operating direction to be reassigned may be set by the choice of the operator, after the warning.

[Fourth Embodiment]

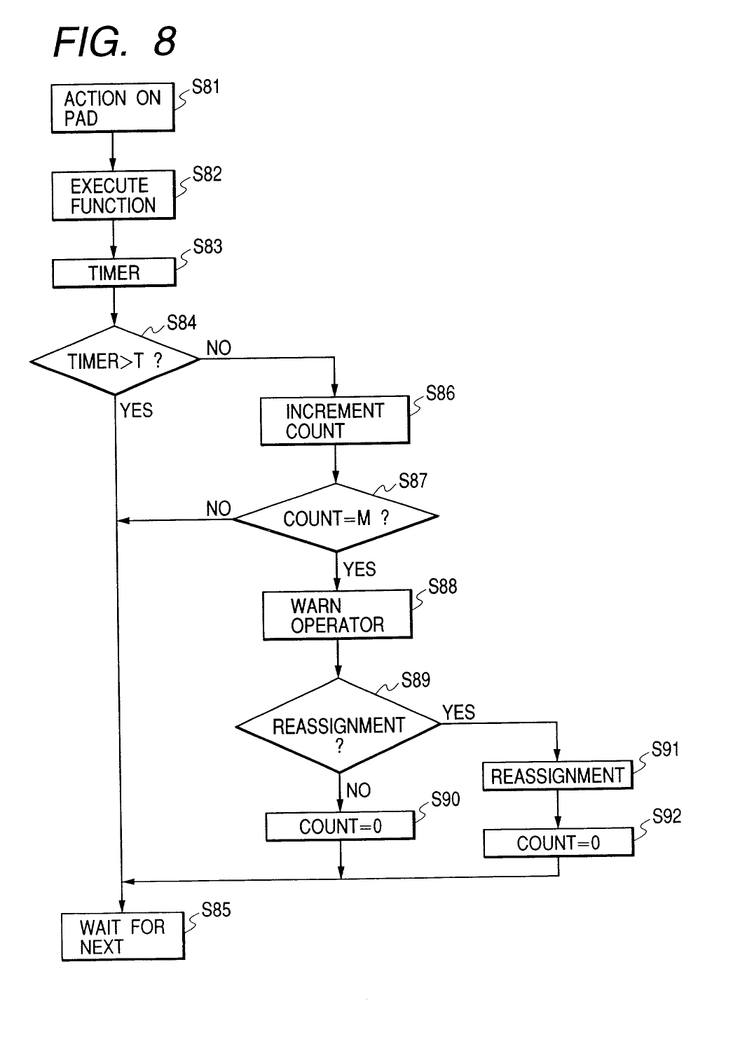

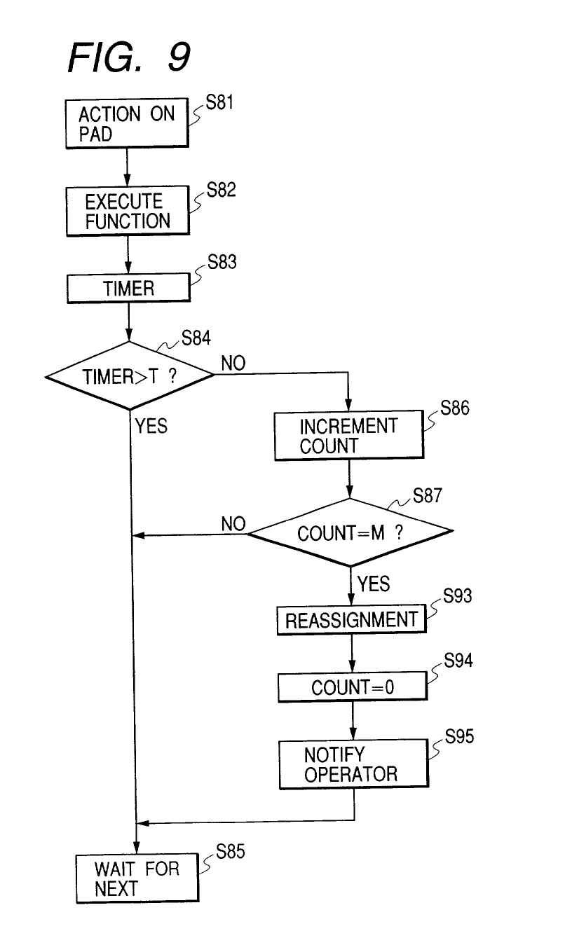

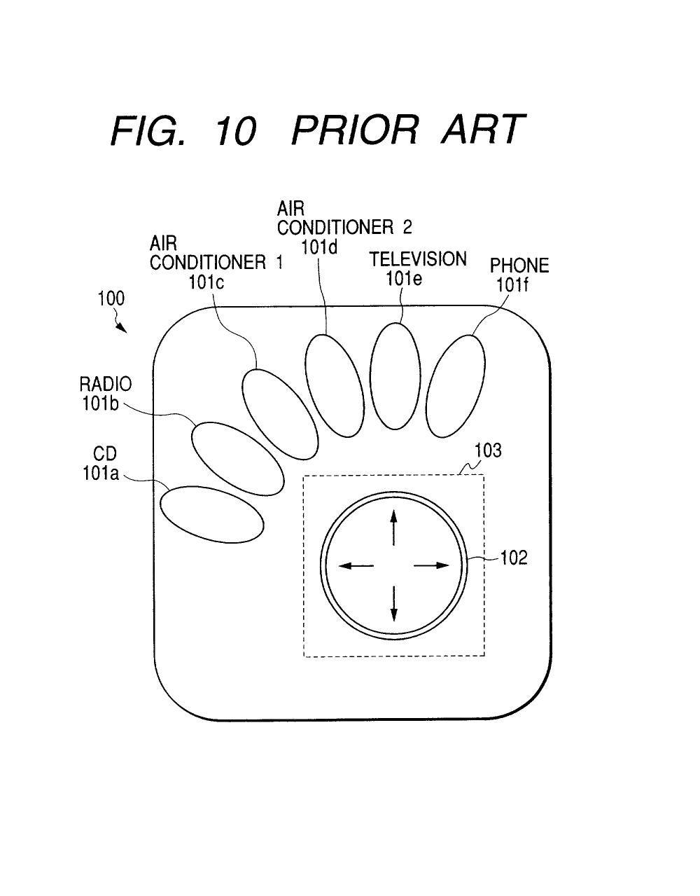

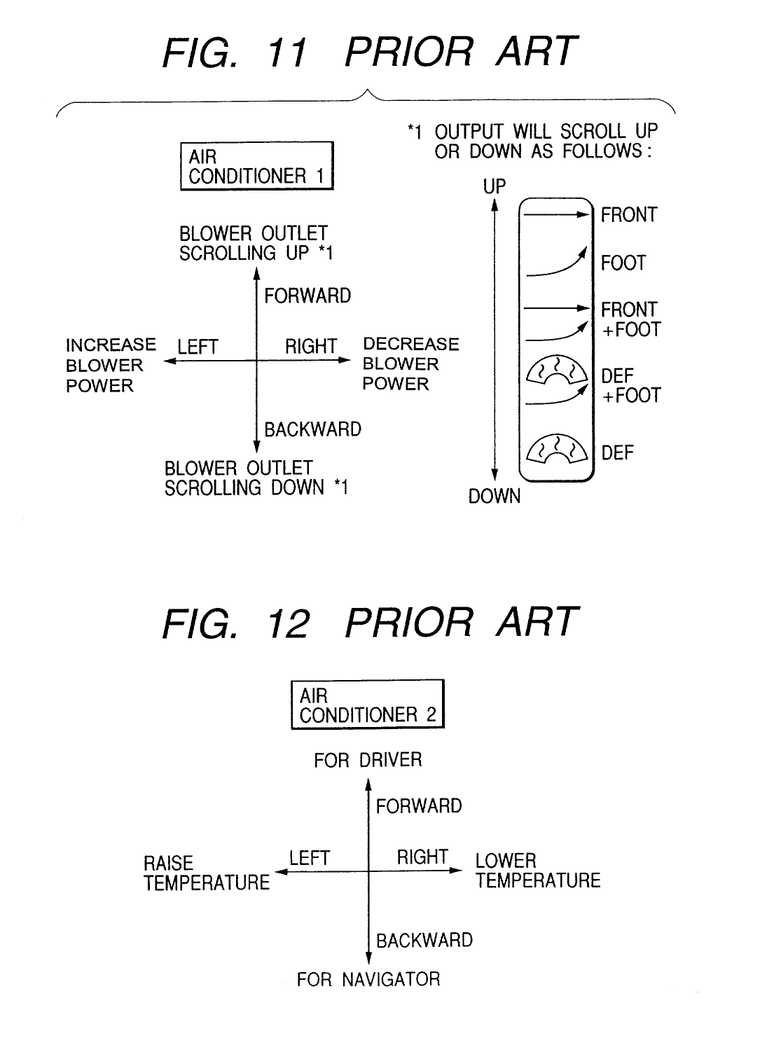

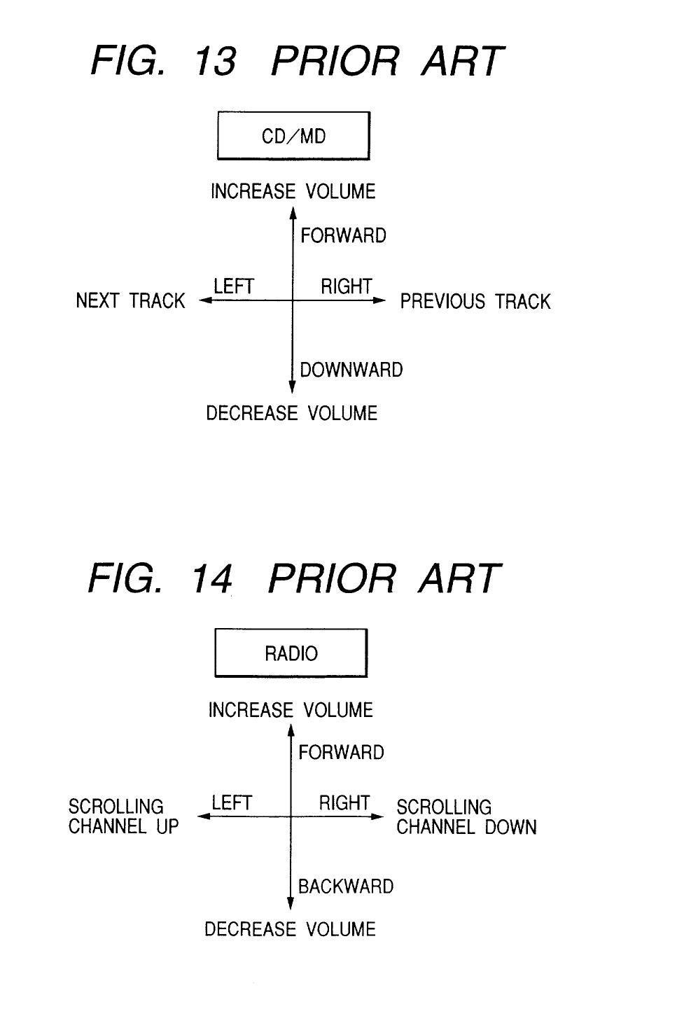

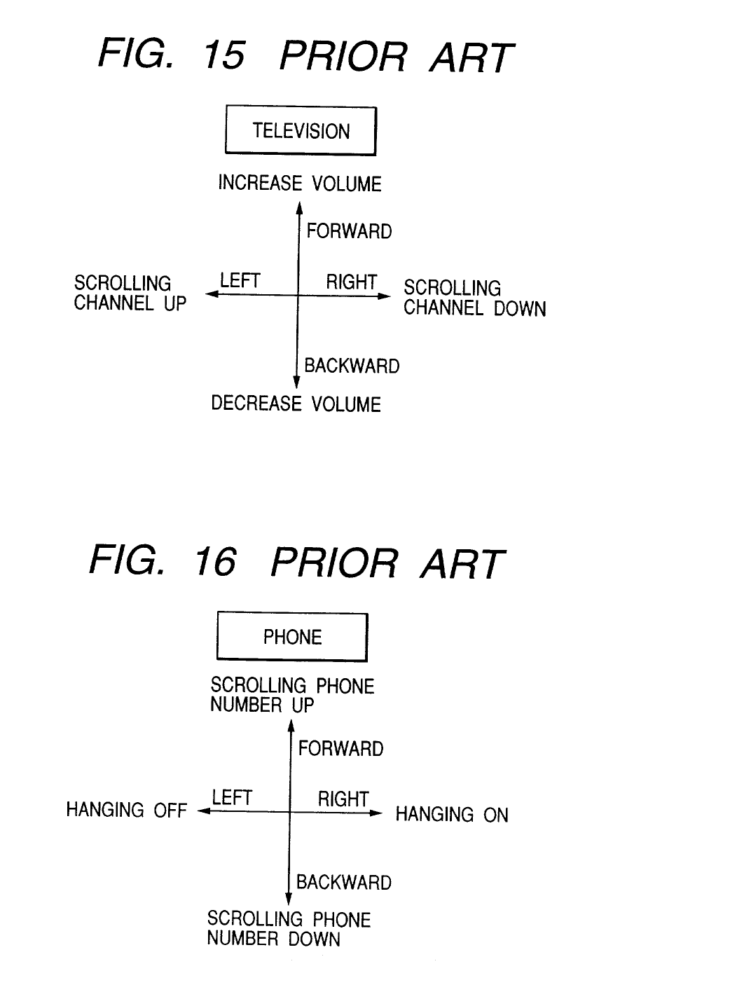

Now a fourth preferred embodiment in accordance with the present invention will be described in greater details with reference to FIG. 9. The input device in accordance with the preferred embodiment has a similar configuration to the input device of the preceding first preferred embodiment as have been described herein above, and the steps S81 to S87 in the operating procedure in FIG. 9 are identical to the corresponding steps of the third preferred embodiment in FIG. 8 of S81 to S87, so that the detailed description of the parts already described in the preceding embodiments will be omitted.

In the control flow of the fourth preferred embodiment, the mistake counter means 15 will compare the counted number of times of mistakes with a predetermined (M) number (step S87). If the count of mistakes is equal to M, then the last selected function stored in the function table 16 and assigned to an operating direction of the manual operating pad 22 will be automatically replaced with another function assigned to another operating direction of the manual operating pad 22 (step S93), the count of mistakes in the last selected operating direction of the manual operating pad 22 will be nullified (step S94), the controller unit 11 will instruct the second warning unit 13 to notify the operator of the reassignment done (step S95) to wait the next action on the manual operating pad 22 (step S85).

In a manner as have been described above, a function assigned to an operating direction of the manual operating pad 22 most prone to frequently make mistakes will be automatically swapped with another function assigned to another direction of the manual operating pad 22. After some iteration of the reassignment, the operating directions of the manual operating pad 22 will be most suitably conformed to the habit and subjective bias of the operator, ultimately resulting in a significant decrease of mistaken actions on the manual operating pad 22. Since the controller unit notifies of the reassignment each time, the operator may confirm the automatic reassignment and will be assured.

Also, it is clear for those skilled in the art that, while in the preferred embodiments described herein the count of mistakes has been described to be incremented, the count may be equivalently decremented by counting the number of mistakes, and invariably the count will reach to a predetermined threshold, the present invention may achieve a similar effect in both manners.

Although the input device in accordance with the present invention has been described by way of example in an input device for the electric components equipped in a vehicle, it is clearly appreciated by the one skilled in the art that the present invention may be embodied in other specific forms without departing from the spirit or essential characteristics thereof. For instance, the input device can be equivalently applied to any home-use appliances such as a microwave oven, to an input device for a personal computer, or to a cellular phone.

As can be appreciated by those skilled in the art from the foregoing description, the input device in accordance with the present invention comprising a plurality of function switches each provided corresponding to a plurality of electronic devices for selecting one of these devices; a controller unit for controlling these electronic devices; a warning unit for generating warning signals for informing an operator of mistaken actions; and a mistake counter means for monitoring the action by the operator to count and store the number of mistakes for each of function switches; the mistake counter means incrementing the counted number of mistakes by determining, when a function switch is pressed within a predetermined period of time after another one of function switches has been pressed, that the preceding switch operation is a mistake; and the controller unit instructing the warning unit to generate warning signals when the counted number of mistakes reaches a predetermined threshold number. The operator may recognize which function switch is most prone to make a mistake, and will take care of operation much carefully when acting on the erroneous operation, resulting in a gradually decrease of erroneous operation on the function switches.

In addition, in accordance with the present invention, the controller unit allows the electronic device selected by a function switch operated in the first action to be replaced with another device assigned to another function switch after generating warning signals. The operator is allowed thereby to decide whether to perform the reassignment of a device assigned to the most erroneously operating function switch with another device assigned to another function switch. When performing the reassignment and after some iteration of the reassignment, the device assignment on the function switches 21a to 21f will be modified to be most suitably conformed to the habit and subjective prejudice of the operator, ultimately resulting in a significant decrease of mistaken actions on the function switches, without a complex procedure of customization.

Also, the input device in accordance with the present invention comprises a plurality of function switches each provided corresponding to a plurality of electronic devices for selecting one of these devices; a controller unit for controlling these electronic devices; and a mistake counter means for monitoring the action on the device to count and store the number of mistakes for each of function switches; the mistake counter means incrementing the counted number of mistakes by determining, when a function switch is pressed within a predetermined period of time after another one of function switches has been pressed, that the preceding switch operation is a mistake; and the controller unit replacing the electronic device selected by the function switch operated in the preceding action with another electronic device selected by another function switch, when the counted number of mistakes reaches a predetermined threshold number. The component that is assigned to a function switch most prone to make a mistake will be automatically swapped with another component assigned to another function switch. After some iteration of this reassignment, the device assignment on the function switches 21a to 21f will be modified to be most suitably conformed to the habit and subjective bias of the operator, ultimately resulting in a significant decrease of mistaken actions on the function switches, without responding to warning signals from the warning unit each time.

In addition, the present invention comprises a warning unit for generating notification signals for informing an operator of the automatic reassignment, the controller unit instructing the warning unit to generate notification signals when the device reassignment has been performed. The operator may confirm the reassignment to be assured.

In addition, in accordance with the present invention, function switches may be provided in the instrument panel and the electronic devices selected by the function switches may be the electric components equipped in an automobile. Since while driving a vehicle such operations have to be done in blind touch, driving will be much safer while operating these function switches.

Also, the input device in accordance with the present invention comprises a plurality of function switches each provided corresponding to a plurality of electronic devices for selecting one of these devices; a manual operating pad manipulatable in two or more directions for selecting a functionality of electronic device by the operating direction; a controller unit for instructing electronic devices to execute functions; a warning unit for generating warning signals for informing an operator of mistaken actions; a mistake counter means for monitoring the action by the operator to count and store the number of mistakes for each of function switches; the mistake counter means incrementing the counted number of mistakes in operating directions by determining, when the manual operating pad is operated in a direction within a predetermined period of time after the manual operating pad has been operated in another direction, that the preceding switch operation is a mistake; and the controller unit instructing the warning unit to generate warning signals when the counted number of mistakes reaches a predetermined threshold number. The operator may recognize the operating direction of the manual operating pad the most prone to make a mistake, and will take care of the action thereafter when operating the most erroneous function, resulting in a gradual decrease of actions on the manual operating pad.

In addition, in accordance with the present invention, the assignment of the electronic device selected in the preceding action to an operating direction can be swappable with another assignment of another device selected in another direction by means of the controller unit after generating warning signals. The operator may have option to perform or not a reassignment of the operating direction with another function assigned to another direction. When instructing to do and after some iteration of the reassignment, the device assignment on the operating directions of the manual operating pad will be modified to be most suitably conformed to the habit and subjective prejudice of the operator, ultimately resulting in a significant decrease of mistakes on the pad operation, without a complex procedure of customization.

Also the present invention comprises a plurality of function switches each provided corresponding to a plurality of electronic devices for selecting one of these devices; a manual operating pad manipulatable in two or more directions for selecting a functionality of electronic device by the operating direction; a controller unit for instructing electronic devices to execute functions; and a mistake counter means for monitoring the operation to count and store the number of mistakes in each operating direction of the manual operating pad; the mistake counter means incrementing the counted number of mistakes in an operating direction by determining, when the manual operating pad is operated in another direction within a predetermined period of time after the pad has been operated in a direction, that the preceding switch operation is a mistake; and the controller unit replacing the function selected by the operating direction in a preceding action with another function selected in a succeeding action, when the counted number of mistakes reaches a predetermined threshold number. The function assigned to an operating direction most prone to make a mistake by the operator will be automatically swapped with another function assigned to another direction, and some iteration of the reassignment, the function assignment on the operating directions will be modified to be most suitably conformed to the habit and subjective bias of the operator, ultimately resulting in a significant decrease of mistaken actions on the manual operating pad, without responding to warning signals from the warning unit each time.

In addition, the present invention further comprises a warning unit for generating notification signals for informing the operator of the reassignment done; and the controller unit instructing the warning unit to generate notification signals when the device reassignment has been performed. The operator may recognize the reassignment and will be assured to operate on the manual operating pad.

Furthermore, in accordance with the present invention, function switches and manual operating pad may be mounted in the instrument panel of a vehicle and the electronic devices may be the electric components equipped on board selected by the function switches, as well as the functions are individual functions of each of those components. Since while driving a vehicle such operations have to be done in blind touch, driving will become much safer while operating these function switches and manual operating pad.

The foregoing description of preferred embodiments of the invention has been presented for purposes of illustration and description thereof. It is to be recognized that the embodiments are not intended to be exhaustive or to limit the invention to the precise forms disclosed, and modifications and variations are possible in light of the above teachings or may be acquired from practice of the invention. The embodiments chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An input device, comprising:
a plurality of function switches each provided corresponding to a plurality of electronic devices for selecting one of these devices;
a controller unit for controlling the electronic devices;
a first warning unit for generating warning signals for informing an operator of the function switches of a mistaken action on the function switches; and
a mistake counter means for monitoring the operation on the function switches to count and store the number of mistakes on each of the function switches, wherein
the mistake counter means increments the counted number of mistakes by determining, when one of the function switches is operated within a predetermined period of time after another function switch has been operated, that the preceding switch operation is a mistake; and
the controller unit instructs the first warning unit to generate the warning signals when the counted number of mistakes reaches a predetermined threshold number.

2. An input device according to claim 1, wherein the controller unit allows the electronic device selected by a function switch operated in the first action to be replaced with another device assigned to another function switch after generating the warning signals.

3. An input device, comprising:
a plurality of function switches each provided corresponding to a plurality of electronic devices for selecting one of the devices;
a controller unit for controlling the electronic devices; and
a mistake counter means for monitoring the operation on the function switches to count and store the number of mistakes for each of the function switches, wherein
the mistake counter means increments the counted number of mistakes by determining, when one of the function switches is operated within a predetermined period of time after another function switch has been operated, that the preceding switch operation is a mistake; and
the controller unit replaces the assigned electronic device selected by the function switch operated in the preceding action with another electronic device selected by another function switch, when the counted number of mistakes reaches a predetermined threshold number.

4. An input device according to claim 3, further comprising a second warning unit for generating notification signals for informing an operator of the function switches of the automatic reassignment of the electronic device, wherein
the controller unit instructs the second warning unit to generate the notification signals when the device reassignment has been performed.

5. An input device according to claim 1, wherein the function switches are provided in a console box and the electronic devices selected by the function switches are electric components equipped in an automobile.

6. An input device according to claim 2, wherein the function switches are provided in a console box and the electronic devices selected by the function switches are the electric components equipped in an automobile.

7. An input device according to claim 3, wherein the function switches are provided in a console box and the electronic devices selected by the function switches are the electric components equipped in an automobile.

8. An input device according to claim 4, in which:
the function switches are provided in an instrument panel and the electronic devices selected by the function switches are the electric components equipped in an automobile.

9. An input device, comprising:
a plurality of function switches each provided corresponding to a plurality of electronic devices for selecting one of these devices;
a manual operating pad manipulatable in two or more directions for selecting a functionality of the electronic devices by the operating direction;
a controller unit for instructing the electronic devices to execute the function;
a first warning unit for generating warning signals for informing an operator of the manual operating pad of a mistaken action on the manual operating pad; and
a mistake counter means for monitoring the operation on the manual operating pad by the operator to count and store the number of mistakes in each operating direction of the manual operating pad, wherein
the mistake counter means increments the counted number of mistakes in an operating direction by determining, when the manual operating pad is operated in a direction within a predetermined period of time after the pad has been operated in another direction, that the preceding operation is a mistake; and
the controller unit instructs the first warning unit to generate the warning signals when the counted number of mistakes reaches a predetermined threshold number.

10. An input device according to claim 9, wherein the assignment of the electronic device selected by the preceding action to an operating direction can be swapped with another assignment of another device selected in another direction by means of the controller unit after generating the warning signals.

11. An input device, comprising:
a plurality of function switches each provided corresponding to a plurality of electronic devices for selecting one of the devices;
a manual operating pad manipulatable in two or more directions for selecting a functionality of the electronic devices by the operating direction;
a controller unit for instructing the electronic devices to execute the function; and
a mistake counter means for monitoring the operation on the manual operating pad by the operator to count and store the number of mistakes in each operating direction of the manual operating pad, wherein
the mistake counter means increments the counted number of mistakes in an operating direction by determining, when the manual operating pad is operated in a direction within a predetermined period of time after the manual operating pad has been operated in another direction, that the preceding switch operation is a mistake; and
the controller unit replaces the function selected by the operating direction in a preceding action with another function selected in a succeeding action when the counted number of mistakes reaches a predetermined threshold number.

12. An input device according to claim 8, further comprising:
a second warning unit for generating notification signals for informing the operator of the reassignment done; wherein
the controller unit instructs the second warning unit to generate the notification signals when the device reassignment has been performed.

13. An input device according to claim 9, wherein the function switches and the manual operating pad are mounted in a console box of an automobile and the electronic devices are electric components equipped on board selected by the function switches, as well as the functions are individual functions of each of the electric components in an automobile.

14. An input device according to claim 10, wherein the function switches and the manual operating pad are provided mounted in a console box and the electronic devices selected by the function switches are electric components equipped in an automobile, as well as the functions are individual functions of each of the electric components in an automobile.

15. An input device according to claim 11, wherein the function switches and the manual operating pad are provided mounted in a console box and the electronic devices selected by the function switches are electric components equipped in an automobile, as well as the functions are individual functions of each of the electric components in an automobile.

16. An input device according to claim 12, wherein the function switches and the manual operating pad are provided mounted in a console box and the electronic devices selected by the function switches are electric components equipped in an automobile, as well as the functions are individual functions of each of the electric components in an automobile.
